(19) United States
(12) Patent Application Publication
(10) Pub. No.: US 2025/0028925 A1
(43) Pub. Date: Jan. 23, 2025

(54) NFC Based Coins Which Link To Social Media

(71) Applicant: Allen Haghayegh, Miami, FL (US)

(72) Inventor: Allen Haghayegh, Miami, FL (US)

(21) Appl. No.: 18/223,505

(22) Filed: Jul. 18, 2023

(51) Int. Cl. G06K 19/077; G06Q 50/00

(52) U.S. Cl. CPC G06K 19/07716; G06Q 50/01

(57) ABSTRACT

A method, system and computer program product for sharing social media information using a near-field communication (NFC) device is disclosed. The method, system and computer program product includes acts of associating the NFC device with a displayed item such as a consumer product, work of art or audiovisual presentation; transmitting, by the NFC device, one or more components of social media information associated with the displayed item to a wireless interface in proximity with the NFC device; and presenting the one or more components of social media information by a wireless device in communication with the wireless interface. The NFC device is in the form of a coin bearing a logo or name associated with the item and the artist or producer of the displayed item, where the NFC device provides a convenient mechanism to provide social media information to an interested party.

### BACKGROUND

### Technical Field

The present disclosure relates, in general, to near field communication (NFC) of social media information, and more particularly, but without limitation, to near field communications devices that provide social media information of an artist.

Near field communications systems for social media data transfer are known in the art.

U.S. Pat. No. 10,949,725 discloses a method and device of sharing social media profile.

U.S. Pat. No. 10,278,067 discloses methods and systems for associating social media to wireless identifiers.

U.S. Pat. No. 9,693,222 discloses sharing social media profiles using wireless identifiers of a communication device.

US 2022/0366206 discloses a system and method for prominently propagating advertisements and messages from a garment.

US 2022/0164899 discloses near filed communication information sharing.

WO 2021/067414 discloses a method and device for sharing social media profile.

However, current methods of facilitating the sharing of social media profiles may rely on both parties having the same mobile application, operating system, or accounts on the same social media service, limiting the effectiveness of these methods.

Therefore, a need exists for a practical, convenient and accessible NFC device to share social media information with interested parties.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A method, system and computer program product for sharing social media information using a near-field communication (NFC) device is disclosed. The method, system and computer program product includes acts of associating the NFC device with a displayed item such as a consumer product, work of art or audiovisual presentation; transmitting, by the NFC device, one or more components of social media information associated with the displayed item to a wireless interface in proximity with the NFC device; and presenting the one or more components of social media information by a wireless device in communication with the wireless interface. The NFC device is in the form of a coin bearing a logo or name associated with the item and the artist or producer of the displayed item, where the NFC device provides a convenient mechanism to provide social media information to an interested party.

The foregoing summary is illustrative only and is not intended to be in any way limiting. In addition to the illustrative aspects, aspects, and features described above, further aspects, aspects, and features will become apparent by reference to the drawings and the following detailed description.

Other systems, methods, features, and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 show an example aspect of an NFC device for sharing social media information.

FIG. 2 shows an example aspect of a communication network including an NFC device for sharing social media information; and

FIG. 3 illustrates a flowchart for acts taken m an exemplary method for sharing social media information using an NFC device.

### DETAILED DESCRIPTION

Social media provides convenient ways for people to connect, for personal and professional relationships. However, it can be unwieldly and time consuming to share a particular social media profile during an in-person interaction, particularly if someone would like to share multiple social media profiles. They may need to verbally communicate the social media profile information and require the other person to search for the profile or attempt to remember the information. Additionally, businesses cards or other objects with the social media profile information can be lost or forgotten. Some methods of facilitating the sharing of social media profiles may rely on both parties having the same mobile electronic device, operating system, or accounts on the same social media service, limiting the effectiveness of these methods. There is a need to make sharing social media profiles and information associated with a displayed item such as a work of art or commercial production more efficient and for such a system to be easily reconfigurable so that a user can change the social media information they choose to share based on different social situations, contexts or types of displayed items.

For context, in the existing social media paradigm, users utilize free, ad-based apps such as Facebook™, Twitter™, Instagram™, and Linked-In™ to push content (e.g., digital data) out via posts. The content is transferred to a data center which is owned and controlled by the respective social media networks and then pulled back into a user's smart device via feeds.

Social media platforms are Internet platforms that allow users to post content and interact with one another. Users of social media platforms often have the ability to engage in conversations with other users privately or publicly; post pictures, videos, audio, and other media; modify content; and utilize other functionality built into the platform. Users of social media are often able to create virtual connections with “friends,” “followers,” or other groups of users who agree to a connection and interaction with a particular user.

While many social media users may engage in social media use for entertainment, communication, or other non-monetary reasons, some users of social media engage in social media use for marketing, business networking, advertising, sales, or other monetary or promotional reasons. In using social media for these reasons, a user may post, publish, or otherwise include content in the user's social media profile and interactions to facilitate the user's individual monetization goals. This is a type of online advertising specifically targeting social media page viewers. On some social media platforms users may change links in their profile frequently to maximize the monetization of their page by linking to new or different advertisers and/or advertisements. Social media information may also be used to promote an artist's works among a network of fellow artists, brokers and communities. However, a work of art or item may be on display remote from a computer or wireless device that would allow someone to find out more information about the item, its artist or producer or other useful social media information associated with the item. Moreover, important information about the item may not be readily apparent to even allow an interested party to look up the social media information associated with the displayed item.

Near Field Communication (NFC) is a set of communication protocols that enables communication between two electronic devices over a distance of 4 cm (1.57 in) or less. NFC offers a low-speed connection through a simple setup that can be used to bootstrap more capable wireless connections. Like other “proximity card” technologies, NFC is based on inductive coupling between two so-called antennas present on NFC-enabled devices-for example a smartphone and a printer-communicating in one or both directions, using a frequency of 13.56 MHz in the globally available unlicensed radio frequency ISM band using the ISO/IEC 18000-3 air interface standard at data rates ranging from 106 to 424 kbit/s.

NFC is rooted in radio-frequency identification technology (known as RFID) which allows compatible hardware to both supply power to and communicate with an otherwise unpowered and passive electronic tag using radio waves. This is used for identification, authentication and tracking.

The disclosed NFC system for sharing social media information combines the low-power and low-cost aspects of NFC RFID devices with the ability to link such NFC devices with a wider network to allow personalized social media information related to a product or artist associated with an NFC Reveal Coinsz as described herein.

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

In the following description, numerous specific details are set forth to clearly describe various specific aspects disclosed herein. One skilled in the art, however, will understand that the presently claimed disclosure may be practiced without all of the specific details discussed below. In other instances, well known features have not been described so as not to obscure the disclosure. As described herein, the term “pivotally connected” shall be used to describe a situation wherein two or more identified objects are joined together in a manner that allows one or both of the objects to pivot, and/or rotate about or in relation to the other object in either a horizontal or vertical manner. As described herein, the term “removably coupled” and derivatives thereof shall be used to describe a situation wherein two or more objects are joined together in a non-permanent manner so as to allow the same objects to be repeatedly joined and separated. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. In addition, it should be understood that aspects of the disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the disclosure may be implemented in software. As such, it should be noted that a plurality of hardware and software-based devices, as well as a plurality of different structural components may be utilized to implement the disclosure. Furthermore, and as described in subsequent paragraphs, the specific mechanical configurations illustrated in the drawings are intended to exemplify aspects of the disclosure and that other alternative mechanical configurations are possible.

The following briefly describes the aspects of the disclosure m order to provide a basic understanding of some aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later.

The disclosed NFC system for sharing social media information, such as social media information of an artist for an interested viewer, may be embodied as “Reveal Coinsz,” which may be, in an aspect, plastic, gold-colored “coins” with NFC chips “NFC Tags”) inside them. The NFC Tag is programmable to create easy access to a person's social media profile. In an aspect, each Artist Coin will have the product's name and logo and will measure 1.4 inches in diameter. The Reveal Coinsz will transmit an NFC signal to a receiving device, such as a smartphone, wearable electronic device, tablet, laptop or other wireless-enabled device with NFC transceiver communication functionality. The receiving device may then transmit information associated with the NFC Smart Coin to obtain social media information about the product, the artist or other social media information relevant for product and/or artist associated with the NFC Reveal Coinsz for presentation to a person near the NFC Reveal Coinsz.

The disclosed NFC social media information sharing system will be further illustrated with the detailed description of the following exemplary and non-limiting figures and aspects of the present disclosure.

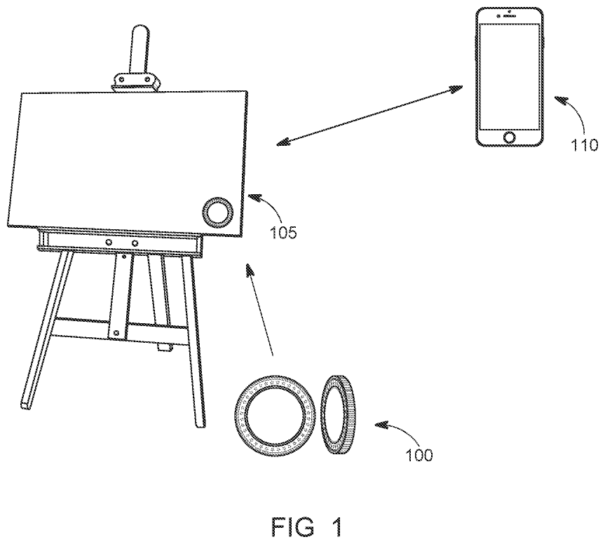

FIG. 1 show an example aspect of an NFC Device 100 (or NFC Tag) for sharing social media information. The NFC Device 100 may be associated with an item 105 of production, art or media associated with a particular artist or entity. The NFC Device 100 may be positioned upon or in close proximity to the item 105. The NFC Device 100 may be designed in various formats, but in an aspect, the NFC Device 100 may be such that each Reveal Coin may be gold-colored and have the product item's 105 name and logo and will measure 1.4 inches in diameter. Other designs, colors, dimensions and shapes of the NFC device (Reveal Coin) 100 may be possible as desired.

In an aspect, the NFC Device 100 includes a radio transceiver such as an RFID transceiver included within the NFC Device 100. The RFID transceiver may operate at a pre-defined frequency and power level as determined by the dimensions of the NFC device 100 and the operating parameters of the NFC Device 100. For example, the RFID transceiver of the NFC Device 100 may be activated upon a certain electromagnetic signal frequency or strength received by the NFC Device 100. In another aspect, a wireless device 110 may be brought into a proximity with the NFC device 100 such that a wireless transceiver within the wireless device 110 may receive an RFID signal from the NFC Device 100 with an RFID transceiver included within the NFC Device 100. In an aspect, the wireless device 110 may be a smartphone, tablet, laptop, wearable device such as a smart watch, smart ring, AV/VR glasses/goggles, or other wearable electronics; desktop computers; wireless networked devices such as printers, set-top boxes, wireless display; and other devices capable of receiving RFID signals from the NFC Device 100. For purposes of this disclosure, a wireless device 110 may be a device that includes a wireless interface for receiving radio-frequency signals, including at least radio-frequency signals associated with RFID devices or RFID tags, as known to one of skill in the art.

The NFC Device 100, upon activation, is configured to transmit an RFID signal comprising social media information related to the item 105, which may be received by the wireless device 110. The social media information may include requests or links to social media accounts that contain social media information related to the item 105. The social media information may include product information, artist information, sales information, performance information, contributor information, photos, videos, text, icons, copyright, trademark or patent information or other relevant social media information associated with the item 105 that the NFC Device 100 is positioned in proximity with.

In an aspect of the disclosure, an owner of an NFC Tag would need to download an application (via smartphone or other wireless/wired device) to assist with installment of their social media platform/platforms they want the NFC Tag to acquire.

The social media information may be obtained from, derived from, requested from, or updated from social media outlets such as Facebook, Twitter, Pinterest, Linkedin Instagram, Reddit, YouTube, twitch, Yelp, Wikipedia, Snapchat, WeChat, WhatsApp, Flickr or other social media outlets known to one of skill in the art. Other social media outlets and sources may be devised in the future that the NFC Device 100 may derive social media information from which fall within the scope of the disclosure.

In an aspect, NFC Reveal Coinz will be sold as blanks, so that the customer of Reveal Coinsz can add their desired social media information.

A benefit of NFC Reveal Coinz is that it allows unlimited tags, allowing any and all people interested to view the content on them.

In an aspect, the social media information transmitted from the NFC Device 100 is presented on the wireless device 110. The wireless device 110 may present audio, video, text or other information based on social media information related to the item 105 that the NFC Device 100 provides when the wireless device 110 is in proximity to the NFC Device 100. The social media information received by the wireless device 110 may include links or requests to access social media sources, such as those described above, to provide additional social media information or updates to social media information sent by the NFC Device 100 to the wireless device 110.

In an aspect, the NFC Device 100 may acquire and store social media information by transmitting, through its embedded RFID transceiver, requests, API calls, push requests, links or requests for links, status and update information associated with the NFC device 100 and item 105 or other social media information requests that may acquire information to update existing social media information stored or referenced by the NFC device 100 associated with the item 105.

The wireless device 110 may be connected to a communications network to relay a signal received from the NFC device 100. The wireless device 110 may transmit a different signal for social media information based on the signal received from the NFC device 100.

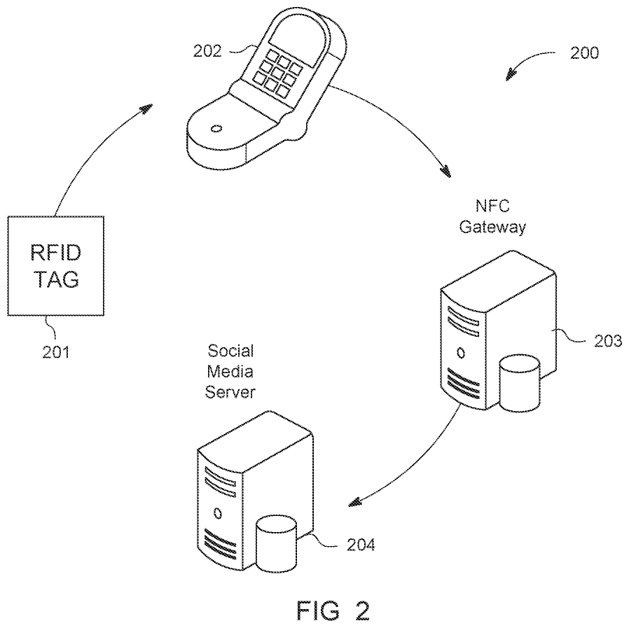

FIG. 2 shows an example aspect of a communication network 200 including an NFC device for sharing social media information. In an exemplary schematic network diagram 200, an NFC device with an RFID Tag 201 is present. As described in relation to FIG. 1, the RFID Tag 201 is included in an NFC Device 100 for sharing social media information with an interested user. The RFID Tag 201 is configured to transmit an RFID signal comprising social media information related to the item 105, which may be received by a wireless device 202. The social media information may include requests or links to social media accounts that contain social media information related to the item 105. The social media information may include product information, artist information, sales information, performance information, contributor information, photos, videos, text, icons, copyright, trademark or patent information or other relevant social media information associated with the item 105 that the RFID Tag 201 is positioned in proximity with.

In an aspect, the wireless device 202 may be a smartphone, tablet, laptop, wearable device such as a smart watch, smart ring, AVNR glasses/goggles, or other wearable electronics; desktop computers; wireless networked devices such as printers, set-top boxes, wireless display; and other devices capable of receiving RFID signals from the RFID Tag 202.

In an aspect, the wireless device 202 may be in communication with an NFC Gateway 203. The NFC Gateway 203 may be part of a communication network that the wireless device 202 is connected to, such as over cellular, WiFi, Bluetooth or other wireless communication network technology. The NFC Gateway 203 is configured to receive NFC-configured information to its proper destination. In an aspect, the NFC Gateway 203 may transmit information from the RFID Tag 201 to a social media server 204 depending on the social media information included in a signal transmitted by the RFID Tag 201.

In an aspect, the social media server 204 may be a server associated with social media information related to a particular social media source or outlet. In an aspect, the social media information may be obtained from, derived from, requested from, or updated from social media outlet servers such as Facebook, Twitter, Pinterest, Linkedin Instagram, Reddit, YouTube, twitch, Yelp, Wikipedia, Snapchat, WeChat, WhatsApp, Flickr or other social media outlets known to one of skill in the art. Other social media outlets and sources may be devised in the future that the RFID Tag 201 may derive social media information from which fall within the scope of the disclosure. In an aspect, the social media information obtained from the social media server 204 may be transmitted back to the wireless device 202 for display or presentation, depending on the requested information from the social media server 204.

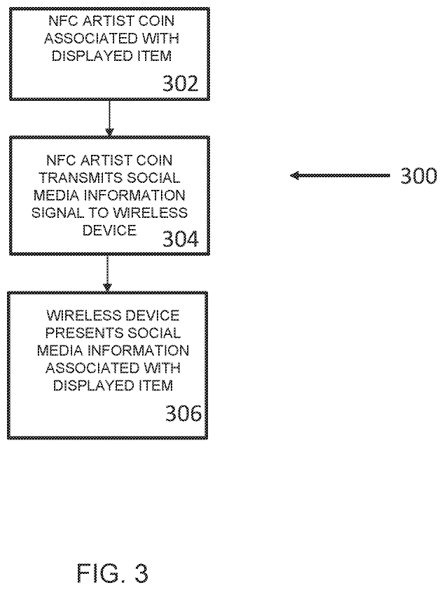

FIG. 3 illustrates a flowchart for acts taken m an exemplary method for sharing social media information with an NFC device. FIG. 3 is explained in conjunction with FIG. 1 and FIG. 2. The control starts at act 302.

At act 302, at initial set-up, an NFC Device, such as the disclosed NFC Reveal Coinsz is associated with a displayed item for associating social media information related to the displayed item. The displayed item may be a consumer product, work of art, visual or audio display, text, advertisement or other displayed item conveying information or structure. In an aspect, the social media information may include product information, artist information, sales information, performance information, contributor information, photos, videos, text, icons, copyright, trademark or patent information or other relevant social media information associated with the displayed item that the NFC Reveal Coinsz is associated with. The NFC Reveal Coinsz is positioned in proximity with the displayed item, embedded within, positioned upon or behind the displayed item or other location in close proximity to the displayed item.

At act 304, the NFC Reveal Coinsz transmits social media information to a wireless device in proximity to the NFC Reveal Coinsz and the displayed item.

In an aspect, the social media information may include requests or links to social media accounts that contain social media information related to the displayed item. The social media information may include product information, artist information, sales information, performance information, contributor information, photos, videos, text, icons, copyright, trademark or patent information or other relevant social media information associated with the displayed item 105 that the NFC Reveal Coinsz is positioned in proximity with.

The social media information may be obtained from, derived from, requested from, or updated from social media outlets such as Facebook, Twitter, Pinterest, Linkedin Instagram, Reddit, YouTube, twitch, Yelp, Wikipedia, Snapchat, WeChat, WhatsApp, Flickr or other social media outlets known to one of skill in the art. Other social media outlets and sources may be devised in the future that the NFC Reveal Coinsz may derive social media information from which fall within the scope of the disclosure.

At act 306, the social media information transmitted from the NFC Reveal Coinsz is presented on the wireless device. The wireless device may display audio, video, text or other information based on social media information related to the displayed item that the NFC Reveal Coinsz provides when the wireless device is in proximity to the NFC Reveal Coinsz. The social media information received by the wireless device may include links or requests to access social media sources, such as those described above, to provide additional social media information or updates to social media information sent by the NFC Reveal Coinsz to the wireless device.

In an aspect, the NFC Reveal Coinsz may acquire and store social media information by transmitting, through its embedded RFID transceiver, requests, API calls, push requests, links or requests for links, status and update information associated with the NFC Reveal Coinsz and the displayed item or other social media information requests that may acquire information to update existing social media information stored or referenced by the NFC Reveal Coinsz associated with the displayed item.

In an aspect, the wireless device may be connected to a communications network to relay a signal received from the NFC Reveal Coinsz. The wireless device may transmit a different signal for social media information based on the signal received from the NFC Reveal Coinsz.

Blocks of the flowchart 300 support combinations of means for performing the specified functions and combinations of operations for performing the specified functions. It will also be understood that one or more blocks of the flowchart 300, and combinations of blocks in the flowchart 300, can be implemented by special purpose hardware-based computer systems which perform the specified functions, or combinations of special purpose hardware and computer instructions. Also, more, fewer or different steps may be provided.

Alternatively, the system may comprise means for performing each of the operations described above. In this regard, according to an example aspect, examples of means for performing operations may comprise, for example, a processor and/or a device or circuit for executing instructions or executing an algorithm for processing information as described above.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an aspect of the present disclosure and executed by the processing circuitry. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for sharing social media information associated with an item, the system comprising:
a near field communication (NFC) device, where the NFC device comprises a radio-frequency identification tag that transmits signals comprising the social media information associated with the item, the signals receivable by a wireless interface of a device; and
a memory configured to store the social media information associated with the item.

2. The system of claim 1, where the item comprises a consumer product, work of art, visual or audio display, text, advertisement or a combination thereof.

3. The system of claim 1, where the social media information comprises product information, artist information, sales information, performance information, contributor information, photos, videos, text, icons, copyright, trademark or patent information or a combination thereof associated with the item.

4. The system of claim 1, where the wireless interface of the device comprises at least one of a wireless interface for a smartphone, a tablet, a laptop, a wearable device, a desktop computers, a wireless printers, a wireless set-top box, a wireless display or a combination thereof.

5. The system of claim 1, where the social media information is derived from Facebook, Twitter, Pinterest, LinkedIn Instagram, Reddit, YouTube, twitch, Yelp, Wikipedia, Snapchat, WeChat, WhatsApp, Flickr or a combination thereof.

6. The system of claim 1, where the NFC device comprises a logo and/or a product name associated with the item, the logo or the product name displayed on an external surface of the NFC device.

7. The system of claim 6, where the NFC device comprises a substantially circular shaped device.

8. A method for sharing social media information using a near-field communication (NFC) device, the method comprising:
associating the NFC device with a displayed item;
transmitting, by the NFC device, one or more components of social media information associated with the displayed item to a wireless interface in proximity with the NFC device; and
presenting the one or more components of social media information by a wireless device in communication with the wireless interface.

9. The method of claim 8, where the displayed item comprises a consumer product, work of art, visual or audio display, text, advertisement or a combination thereof.

10. The method of claim 8, where transmitting by the NFC device, the one or more components of social media information associated with the displayed item comprises transmitting product information, artist information, sales information, performance information, contributor information, photos, videos, text, icons, copyright, trademark or patent information or a combination thereof associated with the item.

11. The method of claim 8, where the wireless interface of the device comprises at least one of a wireless interface for a smartphone, a tablet, a laptop, a wearable device, a desktop computers, a wireless printers, a wireless set-top box, a wireless display or a combination thereof.

12. The method of claim 8, where the one or more components of social media information is derived from Facebook, Twitter, Pinterest, LinkedIn Instagram, Reddit, YouTube, twitch, Yelp, Wikipedia, Snapchat, WeChat, WhatsApp, Flickr or a combination thereof.

13. The method of claim 8, further comprising retrieving the one or more components of social media information from a social media server configured to host the one or more components of social media information associated with the displayed item.

14. A computer program product comprising a non-transitory computer readable medium having stored thereon computer executable instructions, which when executed by one or more processors, cause the one or more processors to share social media information using a near-field communication (NFC) device, the instructions comprising instructions for:
associating the NFC device with a displayed item;
transmitting, by the NFC device, one or more components of social media information associated with the displayed item to a wireless interface in proximity with the NFC device; and
presenting the one or more components of social media information by a wireless device in communication with the wireless interface.

15. The computer program product of claim 14, where the displayed item comprises a consumer product, work of art, visual or audio display, text, advertisement or a combination thereof.

16. The computer program product of claim 14, where the instructions for transmitting by the NFC device, the one or more components of social media information associated with the displayed item comprise instructions for transmitting product information, artist information, sales information, performance information, contributor information, photos, videos, text, icons, copyright, trademark or patent information or a combination thereof associated with the item.

17. The computer program product of claim 14, where the wireless interface of the device comprises at least one of a wireless interface for a smartphone, a tablet, a laptop, a wearable device, a desktop computers, a wireless printers, a wireless set-top box, a wireless display or a combination thereof.

18. The computer program product of claim 14, further comprising instructions for retrieving the one or more components of social media information from a social media server configured to host the one or more components of social media information associated with the displayed item.

19. The computer program product of claim 14, where the NFC device comprises a logo and/or a product name associated with the item, the logo or the product name displayed on an external surface of the NFC device.

20. The computer program product of claim 19, where the NFC device comprises a substantially circular shaped device.
